(19) United States
(12) Patent Application Publication
(10) Pub. No.: US 2025/0315296 A1
(43) Pub. Date: Oct. 9, 2025

(54) CONTROLLER, MEMORY SYSTEM AND COMPUTING SYSTEM

(71) Applicant: SK hynix Inc., Icheon-si (KR)

(72) Inventors: Younghoon MIN, San Jose, CA (US); Jongryool KIM, San Jose, CA (US); Kevin TANG, San Jose, CA (US); Timothy LO, San Jose, CA (US); Shiju LI, San Jose, CA (US)

(21) Appl. No.: 18/968,876

(22) Filed: Dec. 4, 2024

Related U.S. Application Data
(60) Provisional application No. 63/631,664, filed on Apr. 9, 2024.

(51) Int. Cl. G06F 9/50

(52) U.S. Cl. CPC G06F 9/5016; G06F 9/5038

(57) ABSTRACT

When an application of a host device accesses data of a memory system through an indirect memory access method, a call command which is set for processing of a corresponding task is transmitted to the memory system, and the memory system calls a previously stored function on the basis of the call command and provides result data obtained according to the indirect memory access method to the application. Therefore, data processing performance using the memory system may be improved while reducing the number of accesses between the host device and the memory system and a time.

### CROSS-REFERENCE TO RELATED APPLICATION

The present application claims priority under 35 U.S.C. 119(e) to U.S. Provisional Patent Application No. 63/631,664 filed on Apr. 9, 2024, which is incorporated herein by reference in its entirety.

### BACKGROUND

### 1. Technical Field

Embodiments of the present disclosure generally relate to a controller, a memory system and a computing system.

### 2. Related Art

A memory system may include at least one memory which stores data. The memory system may include a controller which controls the operation of the at least one memory.

The memory system may process a request received from an external device located outside the memory system while controlling the operation of the memory according to the request of the external device. The external device may perform data processing while writing data to the memory system or reading data written to the memory system by accessing a region where data is to be stored or is stored in the memory system.

A method in which the external device accesses the memory system may be various, and depending on an access method, delay time or overhead for data processing may increase. Due to this fact, a problem may arise in that the performance of data processing using the memory system may degrade.

### SUMMARY

Various embodiments of the present disclosure are directed to providing measures capable of improving the performance of data processing using a memory system by reducing a time required for an access process for data processing to be performed using the memory system.

In an embodiment, a memory system may include: a plurality of memories; and a controller including a plurality of processing units each of which corresponds to at least one of the plurality of memories, and configured to allocate, when receiving a call command according to a task from an external device, at least one of the plurality of memories for data associated with processing of the task on the basis of a performance mode of the call command and operate a processing unit corresponding to the allocated memory to provide result data for the task to the external device.

In an embodiment, a controller may include: a register configured to store a built-in function; and a control circuit including a plurality of processing units each of which corresponds to each of a plurality of memories located outside, and configured to allocate at least one of the plurality of memories by calling the built-in function according to a call command received from an external device and provide result data corresponding to the call command by operating a processing unit corresponding to the allocated memory.

In an embodiment, a computing system may include: an application configured to execute a task, and generate and transmit a call command according to the task; and a computational memory device including a plurality of processing units and a plurality of memories, and configured to allocate, when receiving the call command, one or more of the plurality of memories for processing of the task on the basis of a performance mode and a scheduling policy of the call command and transmit result data for the task to the application by operating processing units corresponding to the allocated memories.

According to the embodiments of the present disclosure, when processing data using a memory system, by reducing delay time due to the number of accesses to the memory system, it is possible to improve the operational performance of the memory system and a computing system which performs data processing using the memory system.

### BRIEF DESCRIPTION OF THE DRAWINGS

FIG. 1 is a diagram illustrating an example of the schematic configuration of a memory system according to embodiments of the present disclosure.

FIG. 2 is a diagram illustrating an example in which a data read operation is performed in an indirect memory access method for the memory system according to the embodiments of the present disclosure.

FIG. 3 is a diagram illustrating another example in which a data read operation is performed in an indirect memory access method for the memory system according to the embodiments of the present disclosure.

FIG. 4 is a diagram illustrating an example of the configuration of the memory system which operates according to the method illustrated in FIG. 3.

FIG. 5 is a diagram illustrating an example of the operation method of the memory system which operates according to the method illustrated in FIG. 3.

FIGS. 6 to 8 are diagrams illustrating examples of various methods in which the memory system according to the embodiments of the present disclosure processes a task by an application of a host device.

FIGS. 9A to 9J are diagrams illustrating examples of a detailed method in which the memory system according to the embodiments of the present disclosure processes tasks by an application of a host device.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

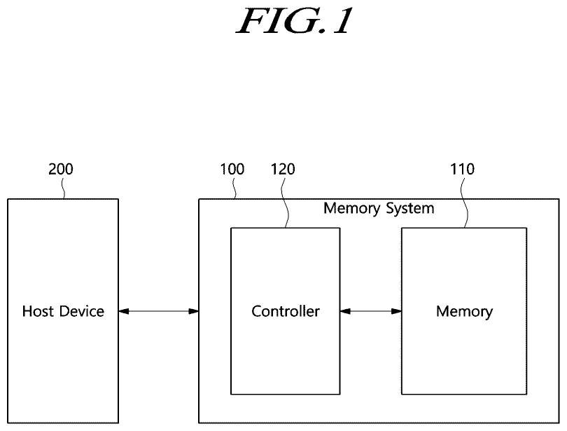

FIG. 1 is a diagram illustrating an example of the schematic configuration of a memory system 100 according to embodiments of the present disclosure.

Referring to FIG. 1, the memory system 100 according to the embodiments of the present disclosure may include at least one memory 110. The memory system 100 may include a controller 120 which controls the operation of memory 110.

The memory 110 may be, for example, volatile memory such as DRAM, SDRAM, DDR SDRAM and LPDDR SDRAM, but the memory 110 according to the embodiments of the present disclosure is not limited thereto. The memory 110 may be nonvolatile memory such as NAND flash memory, 3D NAND flash memory and NOR flash memory. One part of the memory 110 included in the memory system 100 may be volatile memory, and the other part may be nonvolatile memory. Alternatively, the entirety of the memory 110 included in the memory system 100 may be volatile memory, and may be configured with at least two different types of memory 110.

The memory 110 may be one of various types of memory such as resistive RAM, phase change memory, magnetoresistive memory, ferroelectric memory and spin transfer torque memory.

As the case may be, the memory 110 may be processing-in-

memory which includes a computation function or a data processing function. In this case, a logic circuit which performs a computation function may be disposed inside the memory 110, or may be located near the memory 110 outside the memory 110 to perform a computation function. Alternatively, as the case may be, a computation function may be performed by the operation of a memory cell array itself included in the memory 110.

The controller 120 may control the operation of the memory 110 on the basis of a command received from a device located outside the memory system 100 or an internal command. For example, the controller 120 may control an operation of writing data to the memory 110 or reading data written to the memory 110. Depending on the type of the memory 110, the controller 120 may control a refresh operation for preserving data written to the memory 110 or may control an operation of erasing data written to the memory 110. In addition, the controller 120 may control various operations for maintaining or improving the operational performance of the memory 110.

The controller 120 may control the operation of the memory 110 while communicating with a device located outside the memory system 100. The controller 120 may communicate with the external device using various interface protocols. For example, the controller 120 may communicate with the external device through at least one among various protocols such as a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol and an ESDI (enhanced small disk interface) protocol. Alternatively, the controller 120 may communicate with the external device through a compute express Link (CXL) interface. Alternatively, the controller 120 may communicate with the external device through a USB (universal serial bus) protocol, an MMC (multimedia card) protocol, an eMMC (embedded multimedia card) protocol, a UFS (universal flash storage) protocol, an NVMe (nonvolatile memory express) protocol, etc. A method in which the controller 120 performs communication with the external device is not limited to the above-described examples, and communication with the external device may be performed using at least one of various communication interface protocols.

The controller 120 may control the memory 110 according to a request from an external device. For example, the controller 120 may control the operation of the memory 110 according to a command received from a host device 200 which is located outside the memory system 100.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device which provides a 2D or 3D virtual reality image or augmented reality image. In addition to the examples described above, the host device 200 may be any one of various electronic devices which require the memory system 100 capable of storing data for data processing.

The host device 200 may include at least one operating system. The operating system may manage and control overall functions and operations of the host device 200, and may control an interoperation between the host device 200 and the memory system 100. The operating system may be classified into a general operating system and a mobile operating system depending on the mobility of the host device 200.

The host device 200 may be a device which is separated from the controller 120 of the memory system 100. As the case may be, the controller 120 and the host device 200 may be implemented by being incorporated as one device. In this case, the function of the controller 120 may be implemented by being included in the host device 200, and the memory system 100 may perform only a function of controlling the direct operation of the memory 110.

The controller 120 may perform an operation of writing data to the memory 110 or reading data written to the memory 110 according to a request from the host device 200. For example, the controller 120 may receive a logical address managed by the host device 200 and a command, and may perform an operation corresponding to the command while accessing a storage region which is indicated by a physical address of the memory 110 mapped to the corresponding logical address. The host device 200 may perform data processing while accessing the storage region of the memory 110 included in the memory system 100 through the controller 120. The host device 200 may obtain result data immediately in response to the request to the memory system 100, or depending on an access method, may obtain result data by accessing the memory system 100 a multitude of times.

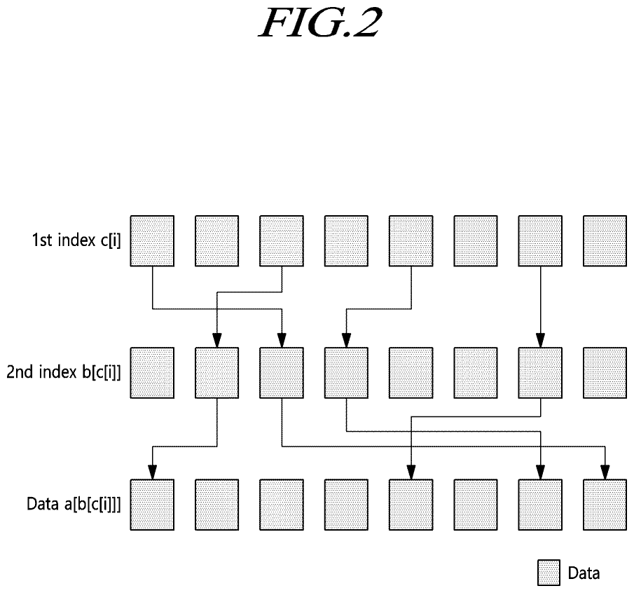

FIG. 2 is a diagram illustrating an example in which a data read operation is performed in an indirect memory access method for the memory system 100 according to the embodiments of the present disclosure.

Referring to FIG. 2, an example of a structure in which data is stored in the memory 110 of the memory system 100 is illustrated. Data stored in the storage region of the memory system 100 may be in a state in which the data is stored according to an indirect memory access method. When performing data processing by reading data stored in the memory system 100, the host device 200 may read the data from the memory system 100 according to the indirect memory access method.

For example, the host device 200 may obtain data c[i] which is stored in a storage region indicated by a logical address associated with data processing. c[i] may be first index data which indicates another storage region.

The host device 200 may obtain data which is stored in the storage region indicated by the first index data c[i]. Data b[c[i]] stored in the storage region indicated by the first index data c [i] may be second index data.

The host device 200 may obtain data which is stored in a storage region indicated by the second index data b[c[i]]. Data a[b[c[i]]] stored in the storage region indicated by the second index data b[c[i]] may be result data which the host device 200 wishes to obtain by the logical address associated with the data processing.

Since the host device 200 obtains result data by accessing storage regions of the memory system 100 through a multitude times in the indirect memory access method, a time required for the host device 200 to obtain and process data using the memory system 100 may increase. The amount of data transmitted and received between the host device 200 and the memory system 100 and the number of communications may increase, and the performance of data processing using the memory system 100 may degrade.

The memory system 100 according to the embodiments of the present disclosure may provide result data according to a request from the host device 200 while reducing the number of accesses to the memory system 100 when data is stored in the memory 110 according to an indirect memory access method.

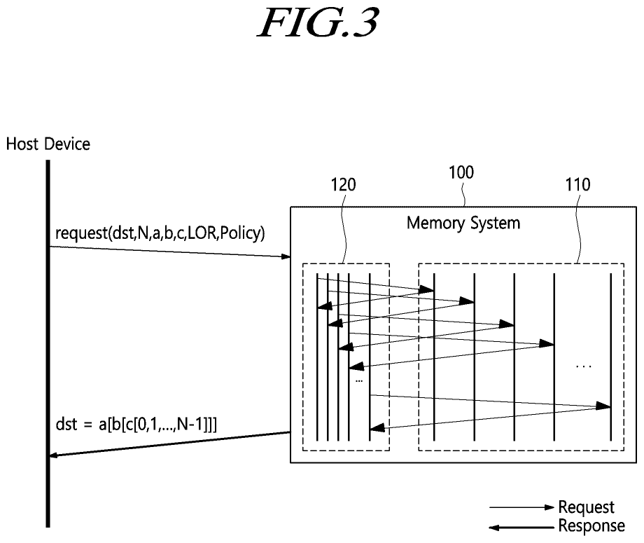

FIG. 3 is a diagram illustrating another example in which a data read operation is performed in an indirect memory access method for the memory system 100 according to the embodiments of the present disclosure.

Referring to FIG. 3, the host device 200 may transmit, to the memory system 100, a command which requests to read data stored in the memory system 100 according to an indirect memory access method. In the present specification, the corresponding command may be referred to as a call command.

The host device 200 may transmit to the memory system 100 a call command which is stored in, for example, a library. The call command may be a command which calls a function stored in the memory system 100. The call command may be implemented with various forms of codes, and for example, may include information which sets the type of result data (e.g., dst) requested by the host device 200 and the types and sizes (e.g., N, a, b and c) of index data and input data used to read the result data in the memory system 100.

In addition, the call command may include information (e.g., LOR) indicating the performance mode of an operation of obtaining the result data by the call command. Moreover, the call command may include information (e.g., policy) indicating a scheduling policy that is a method of performing, when a task by the call command is ended, deallocation for the ended task in the memory system 100.

When receiving a call command from the host device 200, the controller 120 of the memory system 100 may call, according to the call command, a function which is previously stored in the controller 120 or the memory system 100. On the basis of the called function and setting information of the call command, the controller 120 may control an operation of accessing the memory 110 and obtaining result data according to the call command.

For example, the controller 120 may obtain the result data according to the call command while accessing a storage region included in the memory 110 a multitude times on the basis of index data according to the call command. The controller 120 may provide the obtained result data to the host device 200.

Since a plurality of accesses to the memory 110 are made by the controller 120 within the memory system 100, the host device 200 may not access the memory system 100 a multitude times to obtain result data stored according to the indirect memory access method. Because the host device 200 transmits a call command and receives result data from the memory system 100 without data transmission and reception through a multitude of times between the host device 200 and the memory system 100, the host device 200 may efficiently obtain result data and improve data processing performance.

Since it may be regarded that computation or data processing is performed using the memory 110 within the memory system 100 to provide result data to the host device 200, the memory system 100 may also be referred to as a computational memory device or an acceleration memory device.

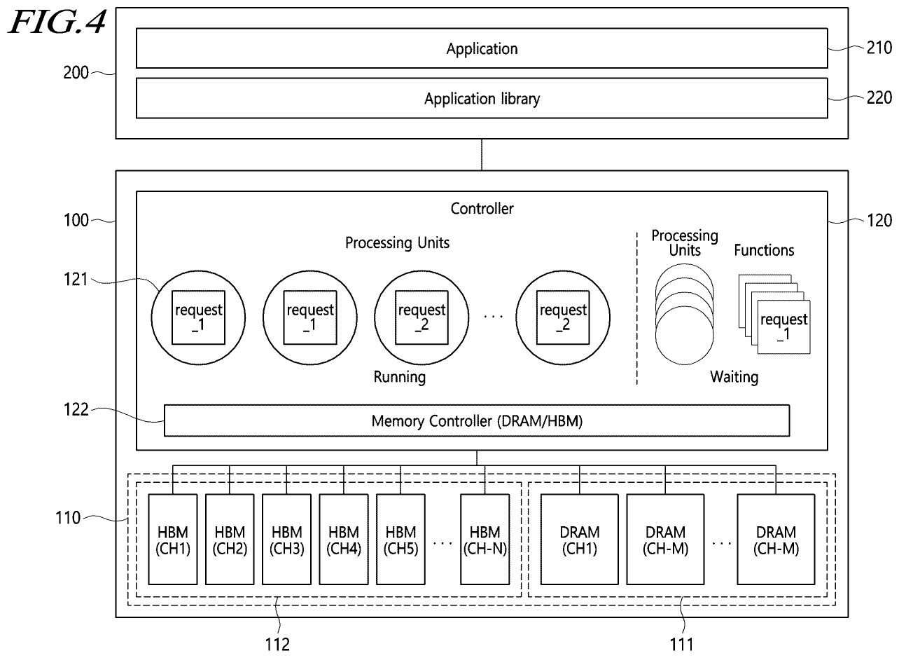

FIG. 4 is a diagram illustrating an example of the configuration of the memory system 100 which operates according to the method illustrated in FIG. 3.

Referring to FIG. 4, the memory system 100 may include the at least one memory 110 and the controller 120. The at least one memory 110 may include volatile memory or nonvolatile memory. The at least one memory 110 may be entirely the same type of memory, may be different types of memory, or may be memory in which the same type of memory is implemented in different forms.

For example, as in the example illustrated in FIG. 4, the memory system 100 may include at least one first memory 111 and at least one second memory 112. The first memory 111 may be a first type of memory, and the second memory 112 may be a second type of memory. The first memory 111 may be, for example, DRAM, and the memory system 100 may include M number of DRAMs. The second memory 112 may be, for example, HBM, and the memory system 100 may include N number of HBMs.

At least one of the channel size and the number of channels of the first memory 111 may be different from at least one of the channel size and the number of channels of the second memory 112.

For example, the channel size of the first memory 111 may be larger than the channel size of the second memory 112. The number of channels of the first memory 111 may be smaller than the number of channels of the second memory 112.

Different types of first memory 111 and second memory 112 may be included in the memory system 100, and the controller 120 may control the first memory 111 and the second memory 112 in various methods to increase the processing efficiency of a call command.

The controller 120 may include, for example, a plurality of processing units 121. Each of the plurality of processing units 121 may correspond to each memory 110 included in the memory system 100. For example, when the M number of first memories 111 and the N number of second memories 112 are included in the memory system 100, the number of the processing units 121 may be M+N.

The controller 120 may include a memory controller 122 for controlling the operation of the memory 110. The memory controller 122 may be included in the controller 120 or, as the case may be, may be disposed separately from the controller 120. The plurality of processing units 121 included in the controller 120 may be referred to as a control circuit, or the plurality of processing units 121 and the memory controller 122 may be collectively referred to as a control circuit.

The controller 120 may include at least one function for performing an operation according to a call command from the host device 200. The controller 120 may include a register which stores at least one function. When receiving a call command, the controller 120 may call a function which is stored in the register, according to the call command, and may obtain result data according to the call command by controlling the processing units 121 and the memories 110.

The host device 200 which transmits a call command to the memory system 100 may include an application 210 and an application library 220.

The application 210 may be a program which operates for data processing in the host device 200. The application 210 may generate a command to be transmitted to the memory system 100 to store or read data required according to an operation. The application 210 may perform data processing while, through a command, storing data in the memory system 100 or reading data stored in the memory system 100.

The application 210 may also generate a call command using the preset application library 220 and transmit the call command to the memory system 100.

The application 210 may transmit a call command to the memory system 100 using the application library 220 and obtain result data which is internally processed in the memory system 100. Even when the application 210 reads data in the indirect memory access method, the performance of data processing using the memory system 100 may be improved.

The controller 120 of the memory system 100 may provide to the host device 200 result data obtained while accessing the memory 110 a multitude of times according to a call command, and may control the processing units 121 included in the controller 120 in various methods on the basis of various setting information such as a performance mode and a scheduling policy set in the call command.

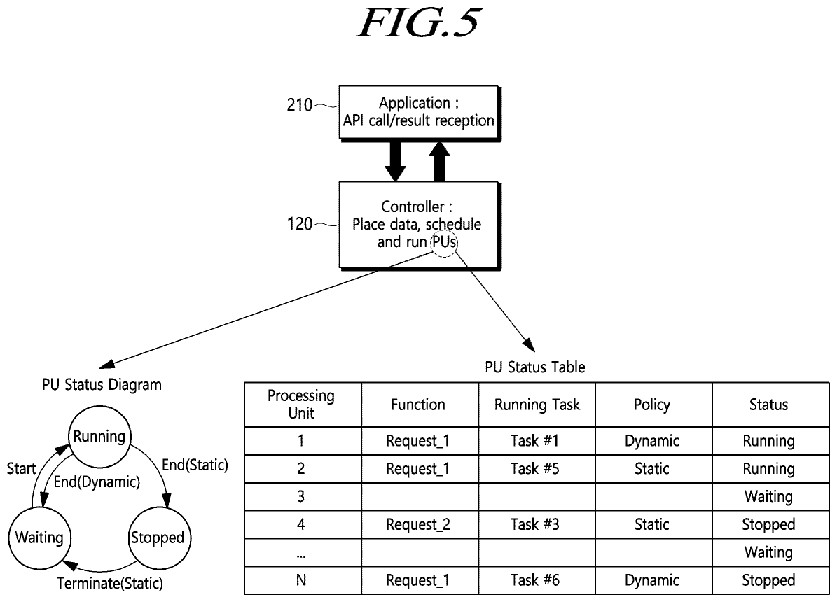

FIG. 5 is a diagram illustrating an example of the operation method of the memory system 100 which operates according to the method illustrated in FIG. 3.

Referring to FIG. 5, the application 210 of the host device 200 may read a call command from the application library 220 and transmit the call command to the controller 120 of the memory system 100.

The controller 120 may process the call command by calling according to the call command a function which is stored in the register and controlling the operations of the memories 110 and the processing units 121. The status of each processing unit 121 according to control of the controller 120 may be, for example, one of a waiting status, a running status and a stopped status.

The waiting status may indicate a status in which the processing unit 121 waits without performing processing according to a call command. As the processing unit 121 starts to operate, the processing unit 121 may be switched from the waiting status to the running status.

The running status may indicate a status in which the processing unit 121 performs processing according to a call command. When the processing unit 121 ends processing, the processing unit 121 may be switched from the running status to the stopped status or the waiting status.

Switching to the stopped status or the waiting status may be performed on the basis of the scheduling policy set in a call command.

For example, in a case where the scheduling policy is a static mode, when processing of a task according to a call command is ended by the processing unit 121, the status of the corresponding processing unit 121 may be switched to the stopped status.

The static mode may mean a mode in which deallocation of the processing unit 121 allocated for processing of a call command is directly performed by the application 210 (a user). When the status of the processing unit 121 becomes the stopped status, deallocation of the processing unit 121 may be performed by the application 210, and before the deallocation, it may be possible to perform processing by utilizing again existing data using the corresponding processing unit 121.

For another example, in a case where the scheduling policy is a dynamic mode, when processing of a task according to a call command is ended by the processing unit 121, the status of the corresponding processing unit 121 may be switched to the waiting status.

The dynamic mode may mean a mode in which deallocation of the processing unit 121 allocated for processing of a call command is performed according to the internal policy of the memory system 100. When the status of the processing unit 121 becomes the waiting status, the processing unit 121 is in a deallocated state and may be allocated and operate for a new task.

The processing units 121 and the memories 110 of the memory system 100 may be allocated to process a task according to a call command of the application 210, and the controller 120 may provide result data to the application 210 when processing of the task is completed.

The application 210 may effectively perform data processing by obtaining result data from the memory system 100 while reducing the number of accesses to the memory system 100.

The controller 120 may process a task according to a call command received from the application 210 while allocating the processing units 121 and the memories 110 in various methods according to setting information of the call command.

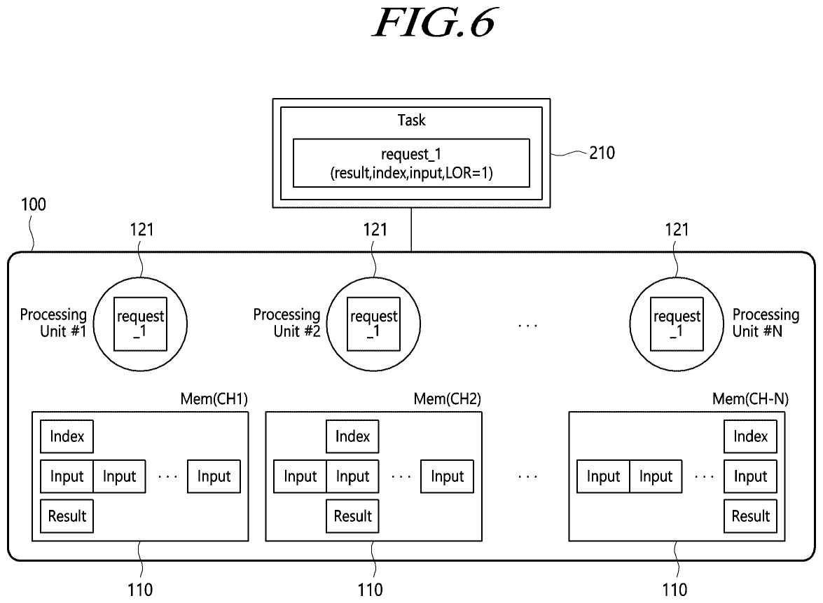

FIGS. 6 to 8 are diagrams illustrating examples of various methods in which the memory system 100 according to the embodiments of the present disclosure processes a task by the application 210 of the host device 200.

Referring to FIG. 6, the memory system 100 may include N number of memories 110. The memory system 100 may include N number of processing units 121 which correspond to the N number of memories 110, respectively. The N number of processing units 121 may be included in the controller 120, and may constitute a control circuit within the controller 120.

The application 210 of the host device 200 may generate a task. The application 210 may perform data processing required for processing of the task, using the memory system 100. The application 210 may read a call command from the application library 220 or generate a call command using the application library 220.

The call command may include various setting information regarding performing of the task. For example, a call command may indicate a one-step indirect memory access method or may indicate a two-step indirect memory access method. In the present specification, a call command which indicates the one-step indirect memory access method may be denoted by request_1, and a call command which indicates the two-step indirect memory access method may be denoted by request_2. As the case may be, a call command may indicate a three or more-step indirect memory access method, and the number of steps may be determined according to the number of index data used to obtain result data.

A call command may include setting information on result data, index data and input data. The result data may mean data to be obtained through the call command. The index data may mean data used to obtain the result data. The input data may mean data which includes index data obtained according to the index data and used to obtain next data.

The call command may include setting information on a performance mode and a scheduling policy. FIG. 6 illustrates as an example a case where a call command includes only setting information on a performance mode.

The performance mode may indicate, for example, a first performance value or a second performance value. The performance mode may indicate a value between the first performance value and the second performance value or a value out of a range by the first performance value and the second performance value.

The first performance value may be, for example, a value that indicates parallel processing of a plurality of tasks rather than performance for rapid processing of a task. For example, the first performance value may be 0, but is not limited thereto. When the performance mode of a call command corresponds to the first performance value, the controller 120 may allocate one processing unit 121 among the plurality of processing units 121 to process a corresponding task.

The second performance value may be, for example, a value that indicates performance for rapid processing of a task. For example, the second performance value may be 1, but is not limited thereto. When the performance mode of a call command corresponds to the second performance value, the controller 120 may allocate all of usable processing units 121 among the plurality of processing units 121 to process a corresponding task.

When a performance mode is a value between the first performance value and the second performance value, the controller 120 may allocate, for a corresponding task, processing units 121 the number of which is proportional to the corresponding value.

When a performance mode is out of the range according to the first performance value and the second performance value, the controller 120 may allocate processing units 121 according to a preset method. For example, when the second performance value is 1 and a performance mode is a value that exceeds the second performance value, the controller 120 may allocate, for a corresponding task, processing units 121 the number of which corresponds to a smaller value between the value according to the performance mode and the number of usable processing units 121.

Besides, a method in which the controller 120 allocates processing units 121 according to the setting information of the performance mode may be various. Through setting of a performance mode in a call command, the application 210 of the host device 200 may control the memory system 100 so that processing for each task may be performed by being optimized.

The memory system 100 which receives a call command from the application 210 may call a function according to the call command, may allocate memories 110 and processing units 121 according to setting information of the call command, and may process a task according to the call command.

Since the performance mode of the call command corresponds to the second performance value, the memory system 100 may allocate all of usable memories 110 among the memories 110 included in the memory system 100 to process the task according to the call command. The memory system 100 may allocate N number of memories 110 and N number of processing units 121 corresponding to the N number of memories 110, respectively, to process the corresponding task.

Each of the N number of memories 110 may be allocated for index data and result data. Input data may be allocated to each of the N number of memories 110. The input data may be allocated to the N number of memories 110 in an overlapping manner. A processing unit 121 corresponding to each of the N number of memories 110 may perform an indirect memory access using index data and input data, and may obtain result data. Result data obtained by the N number of processing units 121 may be provided to the application 210, and processing of the task by the processing units 121 may be ended.

The memory system 100 may differently control allocation of memories 110 and processing units 121 and placement of data for each task depending on the setting value of the performance mode of a call command.

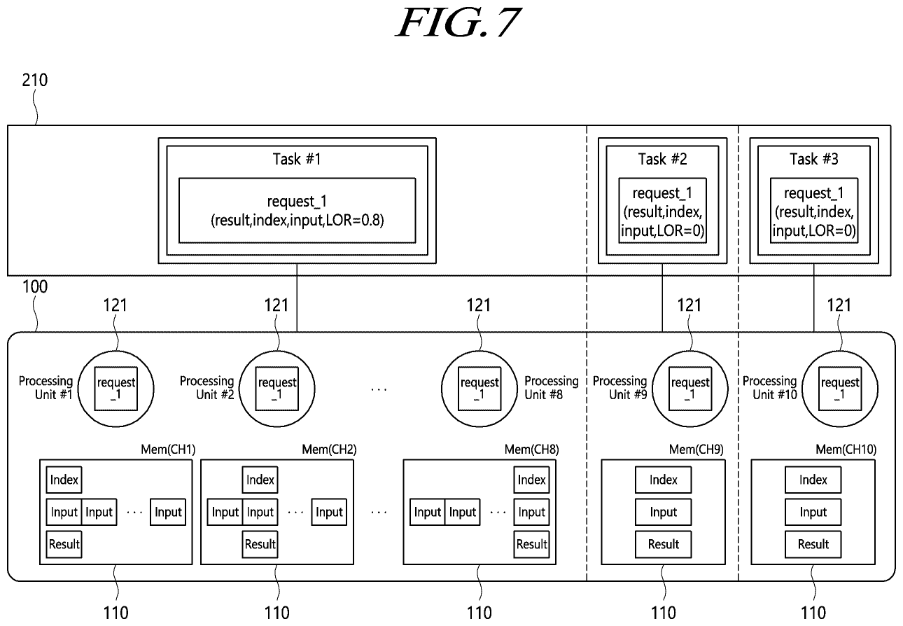

For example, referring to FIG. 7, a task #1 may be requested to be performed according to a call command of the application 210. In the call command which requests the task #1 to be performed, the setting value of a performance mode may be 0.8. Since the setting value corresponds to a value between 0 which is the first performance value and 1 which is the second performance value, the controller 120 may allocate memories 110 and processing units 121 in proportion to the setting value of the performance mode.

For example, as in the example illustrated in FIG. 7, in a case where 10 memories 110 and 10 processing units 121 are included in the memory system 100, eight memories 110 and eight processing units 121 may be allocated to process the task #1.

Since a plurality of memories 110 are allocated to process the task #1, as in the example described above through FIG. 6, index data, input data and result data may be placed in each of the eight memories 110. The input data may be allocated to the eight memories 110 in an overlapping manner. Processing of the task #1 may be performed by the eight processing units 121 corresponding to the eight memories 110.

The application 210 may request, by a call command, a task #2 to be performed. In the call command which requests the task #2 to be performed, the setting value of a performance mode may be 0. Since the setting value of the performance mode corresponds to the first performance value, the controller 120 may allocate one of usable memories 110 and one of usable processing units 121 for the task #2.

One memory 110 and one processing unit 121 may be allocated for the task #2, and the corresponding memory 110 may be allocated for index data, input data and result data.

The application 210 may request, by a call command, a task #3 to be performed, and the setting value of the performance mode of the call command which requests the task #3 to be performed may also be 0. The controller 120 may process the task #3 by allocating one memory 110 and one processing unit 121.

Through setting of a performance mode in the setting information of a call command, optimal processing for each task may be performed.

Depending on the type of a memory 110 included in the memory system 100, the memory system 100 may differently place index data, input data and result data.

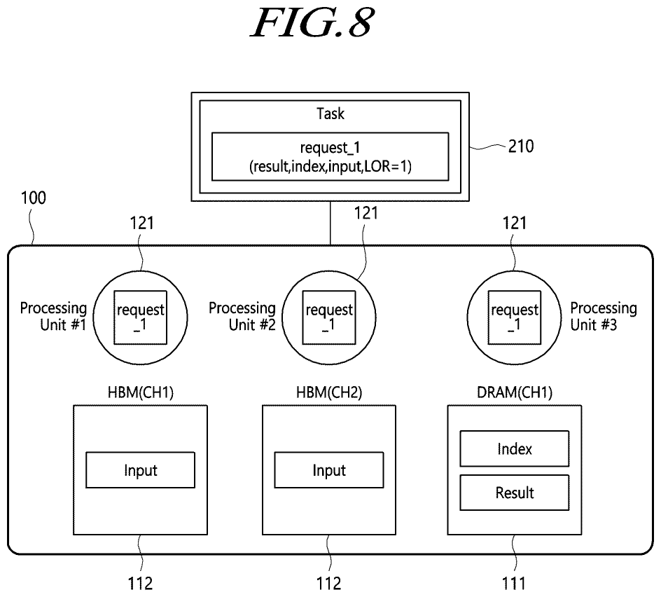

For example, referring to FIG. 8, a case where a first memory 111 and a second memory 112 are included in the memory system 100 is illustrated as an example.

The first memory 111 may be, for example, DRAM. The second memory 112 may be, for example, HBM. Compared to the second memory 112, the first memory 111 may have a larger channel size and a smaller number of channels.

The controller 120 may allocate the first memory 111 for index data and result data. The controller 120 may allocate the second memory 112 for input data which may be frequently accessed during an indexing process.

Processing units 121 of the controller 120 may allocate the first memory 111 for index data and result data, may allocate the second memory 112 for input data, and may perform processing of a task according to a call command.

The setting information of a call command may further include a scheduling policy, and depending on the scheduling policy, the status management of a processing unit 121 whose processing of a task is ended may be differently performed.

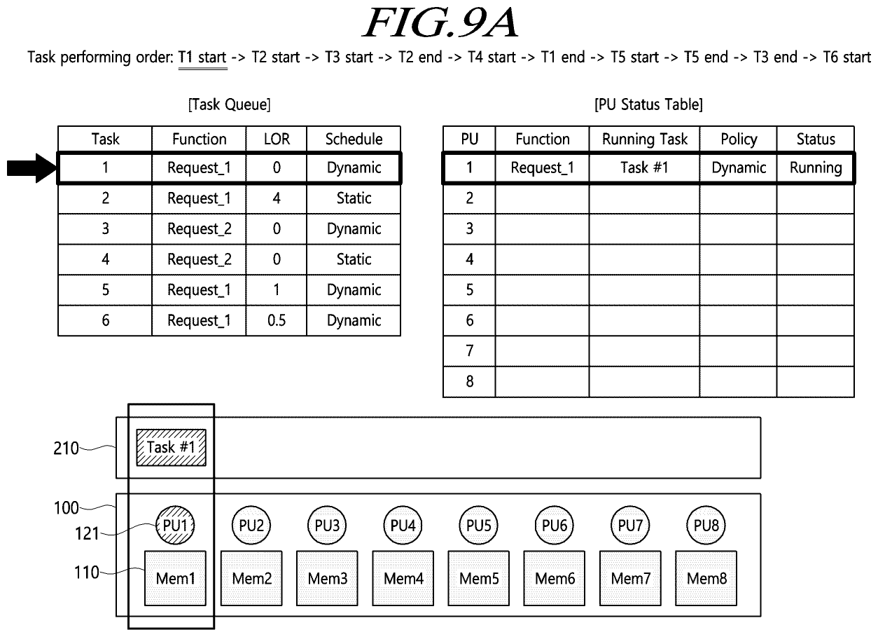

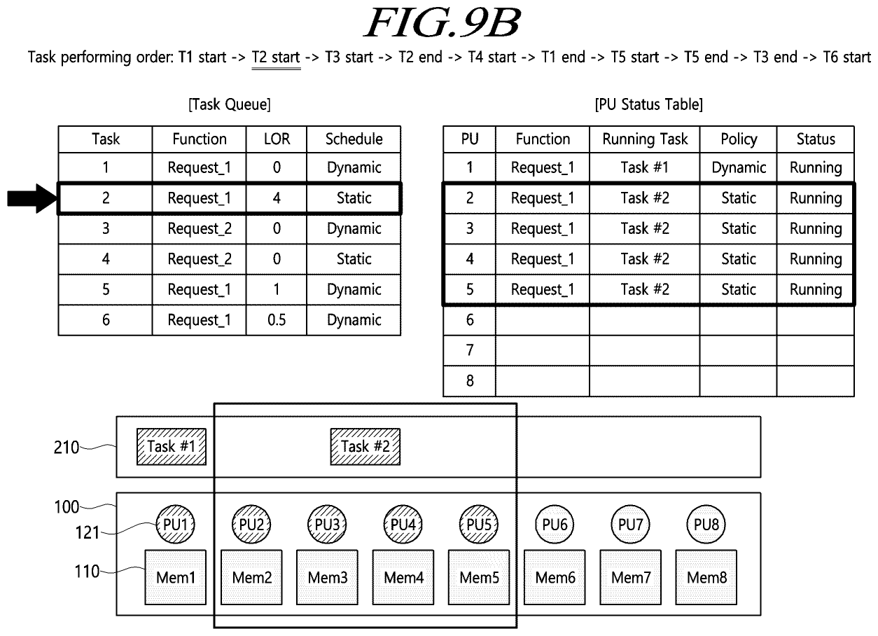

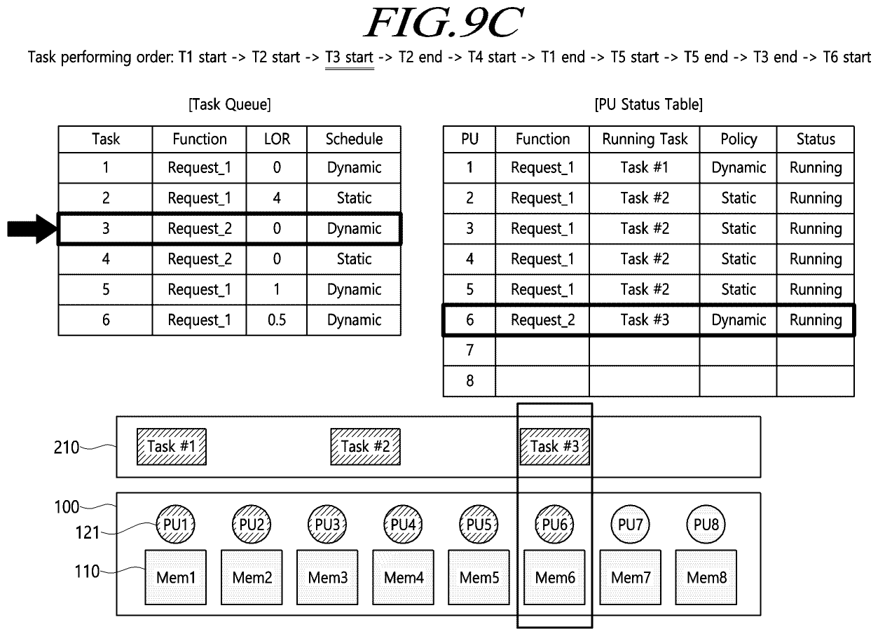

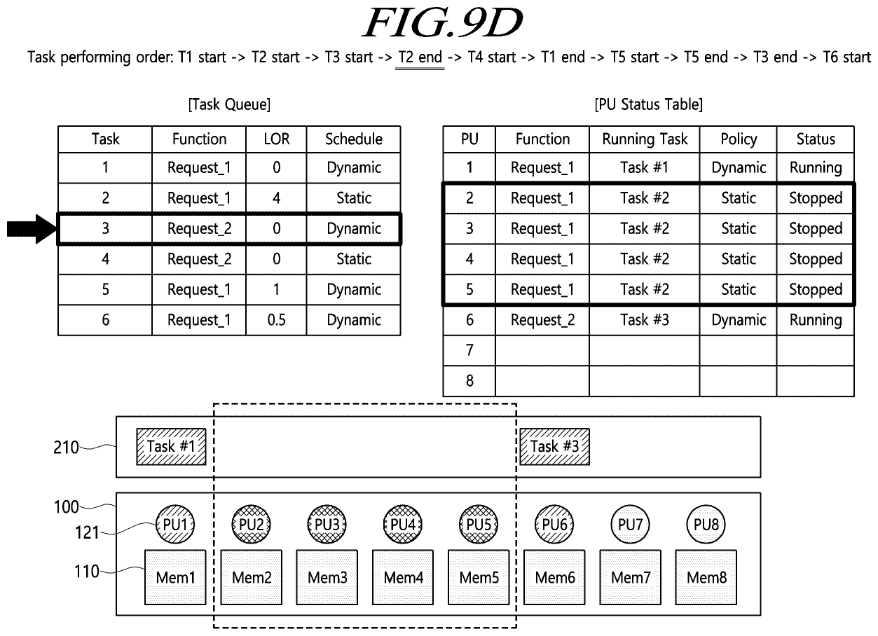

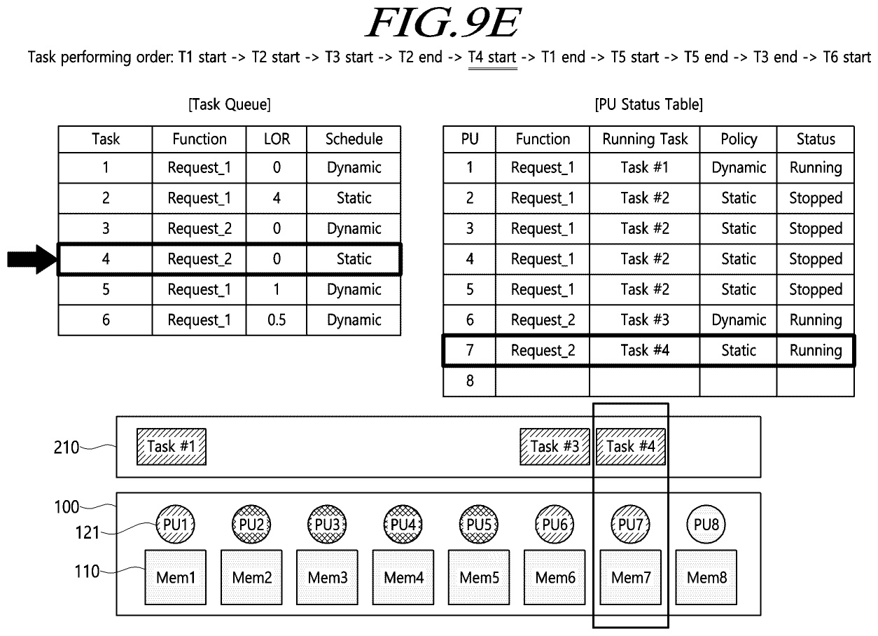

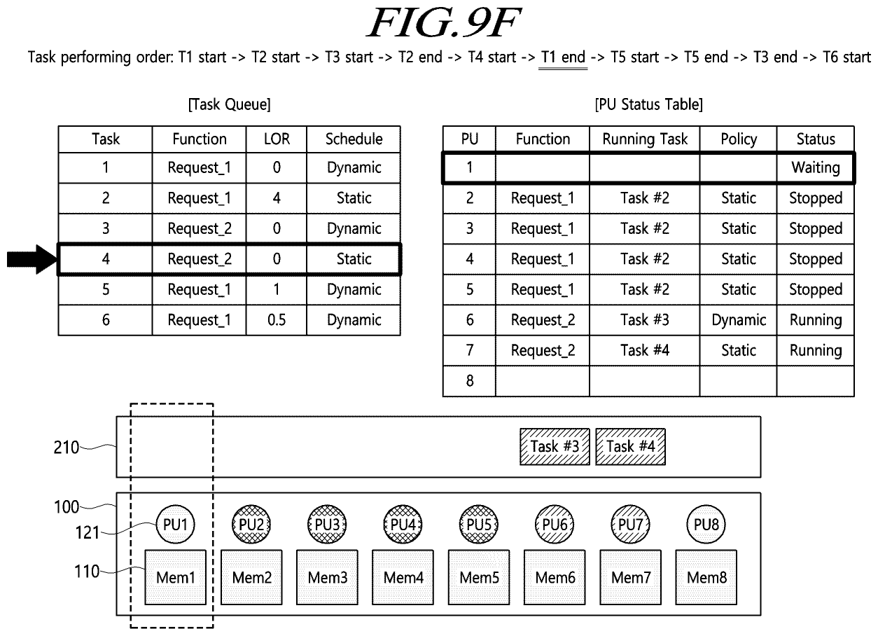

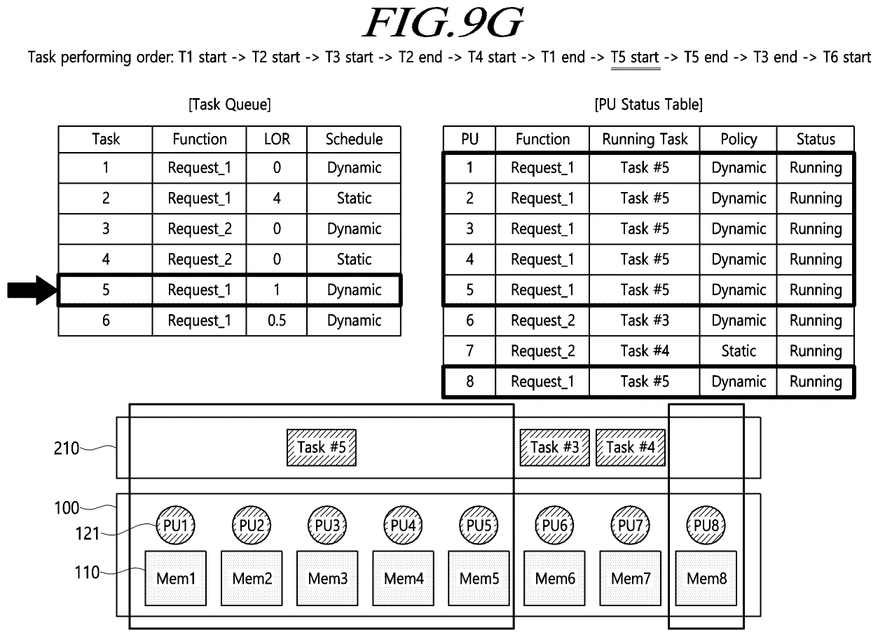

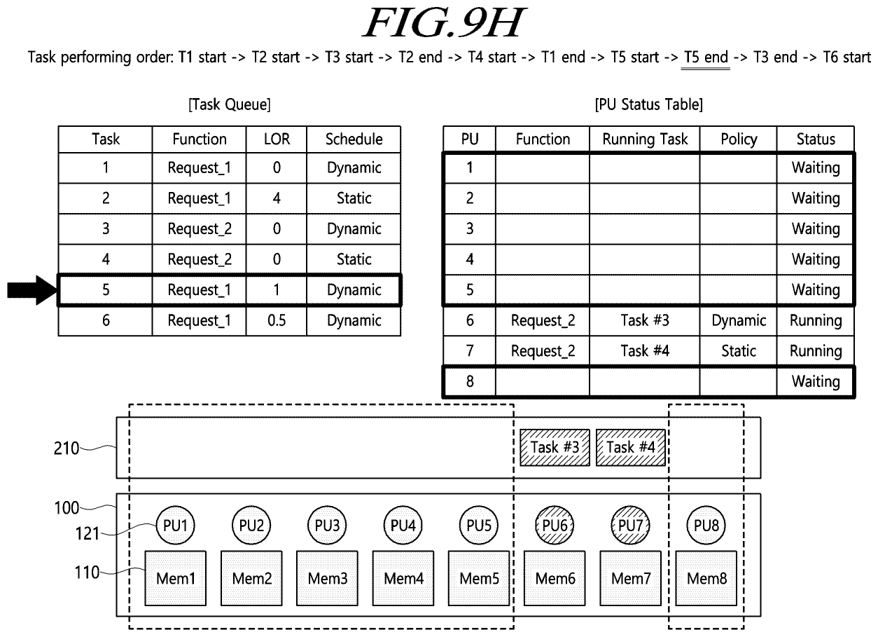

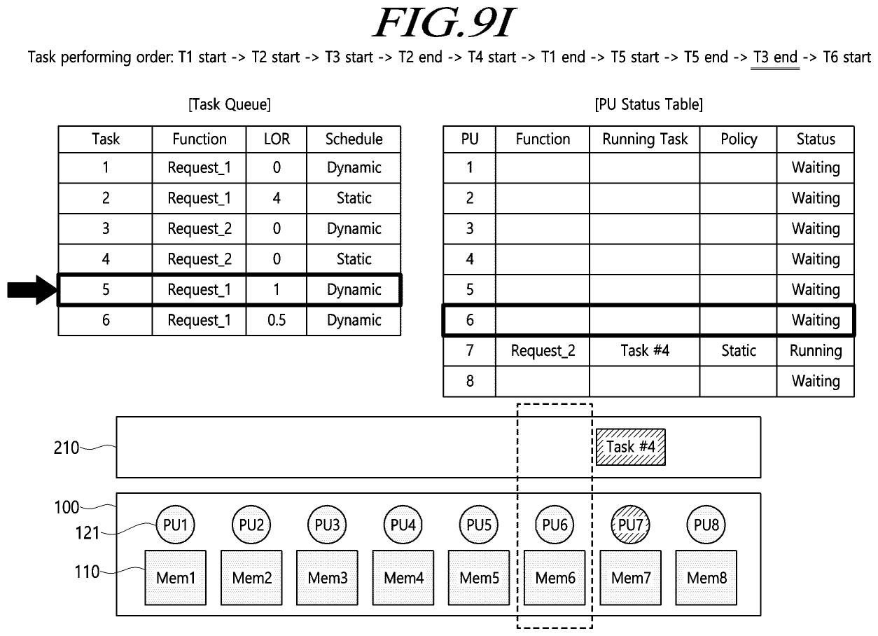

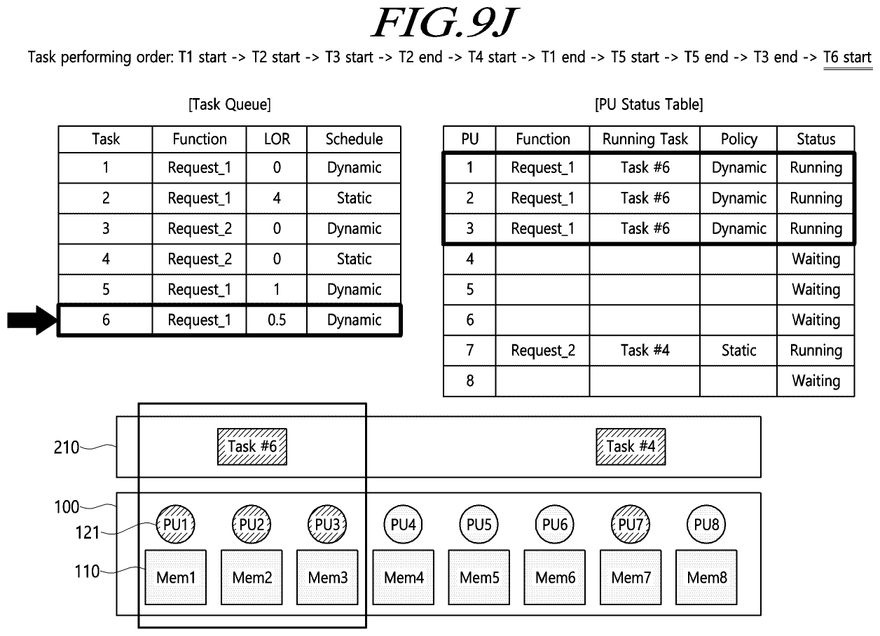

FIGS. 9A to 9J are diagrams illustrating examples of a detailed method in which the memory system 100 according to the embodiments of the present disclosure processes tasks by the application 210 of the host device 200.

Referring to FIG. 9A, an example of a case where eight memories 110 and eight processing units 121 corresponding to the eight memories 110, respectively, are included in the memory system 100 is illustrated.

The application 210 of the host device 200 may transmit a call command corresponding to a task to the memory system 100. A processing method, a performance mode, a scheduling policy, etc. for the task may be indicated by the setting information of the call command.

For example, a call command according to a task #1 may indicate a one-step indirect memory access method, the setting value of a performance mode may be 0 which is the first performance value, and a scheduling policy may indicate a dynamic mode. A scheduling policy may be classified into a dynamic mode and a static mode. In the present specification, a value that indicates the dynamic mode may be referred to as a first policy value, and a value that indicates the static mode may be referred to as a second policy value.

The controller 120 may call a previously stored function according to the setting information of the call command. For example, since the call command indicates the one-step indirect memory access method, a function which reads data in the one-step indirect memory access method may be called.

When receiving the call command for the task #1, the controller 120 may allocate memories 110 and processing units 121 for processing the task #1 according to the setting information of the call command. Since the setting value of the performance mode of the call command is the first performance value, the controller 120 may allocate one memory 110 and one processing unit 121 for the task #1. A scheduling policy is managed as a dynamic mode, and the status of the processing unit 121 PU1 may be managed as a running status.

While performing processing of the task #1 by the processing unit 121 PU1, the memory system 100 may receive a call command for another task.

For example, referring to FIG. 9B, the application 210 may transmit to the memory system 100 a call command for processing of a task #2. The setting value of a performance mode in the setting information of the call command for the task #2 may be 4. In the setting information of the call command, a scheduling policy may indicate a static mode.

Since the setting value of the performance mode of the call command is a value that exceeds the second performance value, the controller 120 may allocate, for the task #2, processing units 121 and memories 110 the numbers of which correspond to 4 as a smaller value between the number of usable processing units 121 and the setting value.

Four processing units 121 PU2, PU3, PU4 and PU5 and four memories 110 Mem2, Mem3, Mem4 and Mem5 included in the memory system 100 may be allocated for the task #2.

Referring to FIG. 9C, a call command for processing of a task #3 may be transmitted to the memory system 100 by the application 210. Since the call command for the task #3 indicates the two-step indirect memory access method, the controller 120 may call a function which processes a task by performing the two-step indirect memory access method among previously stored functions.

The controller 120 may allocate memories 110 and processing units 121 on the basis of the setting information of the call command for the task #3.

For example, in the setting information of the call command for the task #3, the setting value of a performance mode may be 0, and the setting value of a scheduling policy may indicate the dynamic mode.

The controller 120 may allocate one memory 110 and one processing unit 121 for the task #3.

When processing of a task is completed, memories 110 or processing units 121 may be deallocated, and deallocation may be performed on the basis of the scheduling policy of the corresponding task.

For example, referring to FIG. 9D, during processing of the tasks #1, #2 and #3, processing of the task #2 may be ended.

The setting value of the scheduling policy in the setting information of the call command for the task #2 may indicate the static mode. After processing of the task #2 is completed, the controller 120 may maintain the allocation state until a deallocation command which instructs deallocation is received from the application 210. Alternatively, the controller 120 may release the allocation state but may manage existing data in a maintained state. This state may be referred to as the stopped status. The controller 120 may manage the processing units 121 PU2, PU3, PU4 and PU5 allocated for the task #2 in the stopped status.

Thereafter, as in an example illustrated in FIG. 9E, a call command for a task #4 may be transmitted to the memory system 100. In the setting information of the call command for the task #4, the setting value of a performance mode may be the first performance value, and the setting value of a scheduling policy may indicate the static mode.

Since the processing units 121 PU2, PU3, PU4 and PU5 allocated for processing of the task #2 among the processing units 121 of the memory system 100 are in the stopped status, the controller 120 may allocate, for the task #4, one of processing units 121 other than the processing units 121 PU1 and PU6 which are in the running status and the processing units 121 PU2, PU3, PU4 and PU5 which are in the stopped status.

For example, the memory system 100 may allocate a processing unit 121 PU7 and a memory 110 Mem7 for the task #4.

Thereafter, as in an example illustrated in FIG. 9F, processing for the task #1 may be completed.

Since the scheduling policy in the call command for the task #1 indicates the dynamic mode, when the task #1 is processed, the controller 120 may release the allocation state of the processing unit 121 PU1. The status of the processing unit 121 PU1 may be the waiting status, and the processing unit 121 PU1 may be allocated for a new task.

For example, referring to FIG. 9G, a call command according to a task #5 may be generated by the application 210.

In the setting information of the call command for the task #5, the setting value of a performance mode may be 1 which is the second performance value, and the setting value of a scheduling policy may indicate the dynamic mode.

Since the setting value of the performance mode is 1, the controller 120 may allocate, for the task #5, all of usable processing units 121 among the processing units 121 included in the memory system 100. The controller 120 may allocate both the processing unit 121 in the waiting status and the processing units 121 in the stopped status. The processing units 121 in the stopped status may be switched to the waiting status and then be allocated for the task #5 by the application 210, or when the stopped status continues for a predetermined period of time, the corresponding processing units 121 may be switched from the stopped status to the waiting status and be allocated for the task #5.

Thereafter, as in an example illustrated in FIG. 9H, when processing of the task #5 is completed, since the setting value of the scheduling policy of the call command for the task #5 indicates the dynamic mode, all of the allocation states of the processing units 121 allocated for the task #5 may be released. All of the corresponding processing units 121 may become the waiting status.

In addition, as in an example illustrated in FIG. 9I, processing of the task #3 may be completed, and the processing unit 121 allocated for processing of the task #3 may become the waiting status.

Thereafter, processing units 121 may be allocated according to a new task, and for example, as in an example illustrated in FIG. 9J, a call command according to a task #6 may be generated.

In the setting information of the call command according to the task #6, the setting value of a performance mode may be 0.5, and the setting value of a scheduling policy may indicate the dynamic mode.

Since the setting value of the performance mode is 0.5, three processing units 121 may be allocated for the task #6 in proportion to the setting value 0.5 of the performance mode among usable seven processing units 121.

In this way, the controller 120 of the memory system 100 controls, on the basis of setting information such as the performance mode and the scheduling policy of a call command transmitted from the application 210 of the host device 200, allocation of memories 110 and processing units 121 for processing of a task according to the corresponding call command. Therefore, the task according to the call command may be efficiently processed.

In addition, since a function previously stored in the controller 120 is called by the call command and the task is processed, the number of accesses between the host device 200 and the memory system 100 may be reduced, and only result data may be provided to the host device 200 by the memory system 100. Therefore, the operational performance of the memory system 100 which provides result data according to an indirect memory access method and data processing performance using the memory system 100 may be improved.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A memory system comprising:
a plurality of memories; and
a controller including a plurality of processing units each of which corresponds to at least one of the plurality of memories, and configured to allocate, when receiving a call command according to a task from an external device, at least one of the plurality of memories for data associated with processing of the task on the basis of a performance mode of the call command and operate a processing unit corresponding to the allocated memory to provide result data for the task to the external device.

2. The memory system according to claim 1, wherein when the performance mode of the call command corresponds to a first performance value, the controller allocates one of usable memories among the plurality of memories for the data.

3. The memory system according to claim 2, wherein when the performance mode of the call command corresponds to a second performance value, the controller allocates all of the usable memories for the data.

4. The memory system according to claim 3, wherein when the performance mode of the call command exceeds the second performance value, the controller allocates, for the data, a number of memories according to a smaller value between a number of the usable memories and a value corresponding to the performance mode.

5. The memory system according to claim 1, wherein when an operation of the processing unit corresponding to the allocated memory is completed, the controller determines a status of the processing unit on the basis of a scheduling policy of the call command.

6. The memory system according to claim 5, wherein when the scheduling policy of the call command corresponds to a first policy value, the controller deallocates the processing unit without a deallocation command from the external device when the operation of the processing unit is completed.

7. The memory system according to claim 5, wherein when the scheduling policy of the call command corresponds to a second policy value, the controller maintains, when the operation of the processing unit is completed, an allocation state of the processing unit until receiving a command from the external device.

8. The memory system according to claim 1, wherein the controller allocates the allocated memory for index data, input data and the result data, and obtains the result data while performing a plurality of accesses to the allocated memory using the index data and the input data.

9. The memory system according to claim 8, wherein when there are at least two allocated memories, the controller distributes the index data to the allocated memories and operates corresponding processing units to obtain the result data.

10. The memory system according to claim 9, wherein the input data is allocated in an overlapping manner to the memories to which the index data is distributedly allocated.

11. The memory system according to claim 8, wherein the controller allocates a first type of memory among the allocated memories for the index data and the result data, and allocates a second type of memory for the input data.

12. The memory system according to claim 11, wherein a channel size of the first type of memory is larger than a channel size of the second type of memory, and a number of channels of the first type of memory is smaller than a number of channels of the second type of memory.

13. A controller comprising:
a register configured to store a built-in function; and
a control circuit including a plurality of processing units each of which corresponds to each of a plurality of memories located outside, and configured to allocate at least one of the plurality of memories by calling the built-in function according to a call command received from an external device and provide result data corresponding to the call command by operating a processing unit corresponding to the allocated memory.

14. The controller according to claim 13, wherein the control circuit determines a number of memories to be allocated among the plurality of memories on the basis of a performance mode included in the call command.

15. The controller according to claim 13, wherein the control circuit determines whether to deallocate the processing unit corresponding to the allocated memory after an operation of the processing unit is completed, on the basis of a scheduling policy included in the call command.

16. The controller according to claim 13, wherein the processing unit corresponding to the allocated memory obtains the result data while accessing the allocated memory a multitude of times using index data.

17. A computing system comprising:
an application configured to execute a task, and generate and transmit a call command according to the task; and
a computational memory device including a plurality of processing units and a plurality of memories, and configured to allocate, when receiving the call command, one or more of the plurality of memories for processing of the task on the basis of a performance mode and a scheduling policy of the call command and transmit result data for the task to the application by operating processing units corresponding to the allocated memories.

18. The computing system according to claim 17, wherein the computational memory device allocates one or more of the plurality of memories for index data, input data and the result data used for processing of the task.

19. The computing system according to claim 18, wherein the computational memory device allocates the index data to the allocated memories in a distributed manner and allocates the input data to the allocated memories in an overlapping manner.

20. The computing system according to claim 18, wherein
the computational memory device allocates the index data and the result data to a first type of memory among the allocated memories, and allocates the input data to a second type of memory, and
a channel size or a number of channels of the first type of memory is different from a channel size or a number of channels of the second type of memory.
